(19) United States
(12) Patent Application Publication
(10) Pub. No.: US 2008/0278273 A1
(43) Pub. Date: Nov. 13, 2008

(54) Inductor

(75) Inventors: Cheng-Hong Lee, Taoyuan Hsien (TW); Yu-Lin Hsueh, Taoyuan Hsien (TW); Yi-Hong Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/007,337

(22) Filed: Jan. 9, 2008

(30) Foreign Application Priority Data
May 11, 2007 (TW) 096116766

(51) Int. Cl. H01F 27/02

(52) U.S. Cl. 336/83

(57) ABSTRACT

An inductor includes a coil and a magnetic body. The magnetic body covers the coil. The magnetic body includes at least one magnetic material, at least one insulated magnetic material and at least one resin. The magnetic material is enveloped by the insulated magnetic material. Alternatively, the magnetic body is made by mixing the insulated magnetic material with the magnetic material.

### CROSS REFERENCE TO RELATED APPLICATIONS

This Non-provisional application claims priority under 35 U.S.C. §119(a) on Patent Application No. 096116766 filed in Taiwan, Republic of China on May 11, 2007, the entire contents of which are hereby incorporated by reference.

### BACKGROUND OF THE INVENTION

1. Field of Invention

The invention relates to an inductor and, in particular, to an embedded inductor.

2. Related Art

The miniaturization trend of electronic products demands that basic and important components such as the inductors have to be reduced in both weight and size. Moreover, how to maintain low loss and high efficiency while reducing the device sizes is a more important goal of the industry.

To provide an inductor that can stand a large electrical current, operate at high frequencies, has low core loss, and reach no air gap and high operating efficiency, the embedded inductor has been introduced. A conventional embedded inductor includes a coil and a magnetic body. The coil is formed by winding a wire, with a first end and a second end connected with several pins. The magnetic body is made by mixing metal magnetic powders with a resin, followed by pressure casting to cover the coil.

In addition to the magnetic powders as the major ingredient, the magnetic body is usually mixed with insulated powders such as SiO₂, ZnO, TiO₂, Al₂O₃, Fe₂O₃, BN, or BaSO₄ for reducing the core loss caused by the eddy current loss. Since these insulated powders are not magnetic, the magnetic property of the magnetic body is thus diluted. Alternatively, the magnetic powders can be processed at high temperatures to form an oxide film on its surface for insulation. However, as the magnetic body is added with many non-magnetic conducting materials and the magnetic powders thus obtained contain such elements as Si, Al, Cr, Ti, Zr, Nb, or Ta that is easily oxidized, the saturation magnetic flux density of the embedded inductor is greatly reduced. Either case mentioned above definitely affects the efficiency of the embedded inductor.

Therefore, it is an important subject to provide a high performance inductor that can improve the above-mentioned problems.

### SUMMARY OF THE INVENTION

In view of the foregoing, an object of the invention is to provide an inductor that is highly insulated without sacrifice in its magnetic property.

To achieve the above, the invention discloses an inductor including a coil and a magnetic body. The magnetic body covers the coil and is made by mixing at least one insulated magnetic material and at least one resin.

To achieve the above, the invention also discloses an inductor including a coil and a magnetic body covering the coil. The magnetic body includes at least one magnetic material, at least one insulated magnetic material and at least one resin. The insulated magnetic material envelops the magnetic material.

As mentioned above, the inductor of the invention uses at least one insulated magnetic material with good insulating and magnetic properties, the mixture of the insulated magnetic material and a magnetic material, or the insulated magnetic material enveloping the magnetic material, so that the magnetic materials inside the magnetic body are insulated from each other. In comparison with the related art, the insulated magnetic material of the invention is magnetic. Therefore, it simultaneously achieves the goals of insulation as well as maintaining the overall magnetic property. The inductor of the invention thus has better magnetic permeability and saturation magnetic flux density, thereby contributing to high inductance.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of an inductor according to an embodiment of the invention.

### DETAILED DESCRIPTION OF THE INVENTION

The present invention will be apparent from the following detailed description, which proceeds with reference to the accompanying drawings, wherein the same references relate to the same elements.

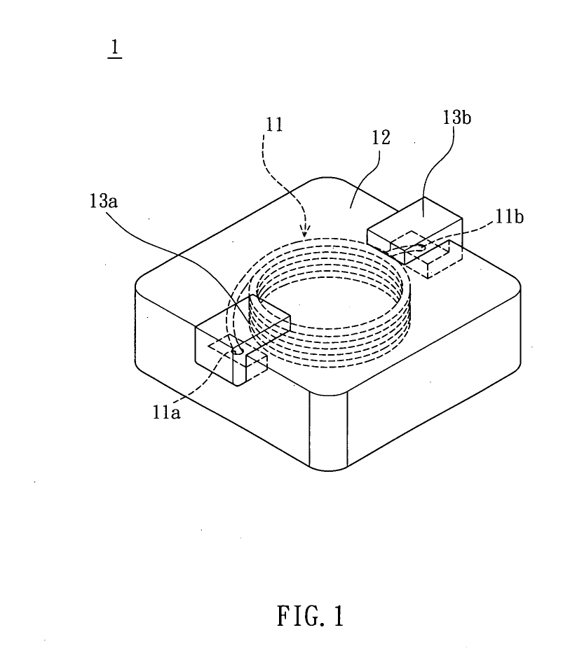

FIG. 1 is a schematic view of an inductor 1 according to an embodiment of the invention. The inductor 1 includes a coil 11 and a magnetic body 12. In this embodiment, the inductor 1 is, for example but not limited to, an embedded inductor.

The magnetic body 12 is used to cover the coil 11. In practice, the coil 11 can be made by winding a round, square or flat wire. The coil 11 has a first end 11a and a second end 11b, which can be directly used as the pins for the inductor 1 to connect with external devices. Alternatively, the first end 11a and second end 11b can also be connected with pins 13a and 13b, which are then connected with external devices.

The magnetic body 12 is made by mixing at least one insulated magnetic material and at least one resin. Explicitly speaking, the insulated magnetic material and the resin are fully mixed and added with a small amount of coupling agent. Afterwards, the mixture is melted and injected into a mold for formation. In this embodiment, the coil 11 can be disposed in the mold in advance.

In this embodiment, the insulated magnetic material can be MnO.Fe₂O₃, NiO.Fe₂O₃, ZnO.Fe₂O₃, or other ferrite magnetic material. The insulated magnetic material can be in the form of powders or granules. Since the insulted magnetic material is highly insulated and magnetic, the inductor 1 still has superior magnetic properties even under the insulated environment. The above-mentioned magnetic properties can be the magnetic permeability and/or the saturation magnetic flux density.

In this embodiment, the resin is an inorganic resin such as aluminum silicates or other Si—Al—O based resin. The resin is about 10% to 40% of the magnetic body 12 in volume. The curing temperature of the magnetic body 12 is thus made between 150° C. and 300° C. Since the resin in this embodiment can withstand a temperature above 400° C., the inductor 1 can be prevented from heat aging in a long-time operation. This largely elongates the lifetime of the inductor 1.

Besides, the resin can be an organic resin such as epoxy. In this case, the cost of the resin can be greatly reduced, thereby making the inductor 1 more competitive.

Moreover, the disclosed magnetic body 12 further includes at least one magnetic material such as Fe, Si, Co, Ni, Al, Mo, or their alloy. The magnetic material is in the form of powders or granules. The magnetic body 12 can be made by mixing the insulated magnetic material with the magnetic material or by enveloping the magnetic material with the insulated magnetic material before the formation. In this case, the insulated material occupies about 1% to 10% of the magnetic body 12 in volume.

The insulated magnetic material envelops the magnetic material by directly coating on its surface. The coating method can be sol-gel, hydrothermal, co-precipitation or some other method. Each magnetic material is uniformly enveloped by the insulated magnetic material, so that the magnetic body is both highly insulated and highly magnetic.

In summary, the inductor of the invention uses at least one insulated magnetic material with good insulating and magnetic properties. The insulated magnetic material is mixed with or envelops the magnetic material, so that the magnetic materials inside the magnetic body are insulated from each other. In comparison with the related art, the insulated magnetic material of the invention is magnetic. Therefore, it simultaneously achieves the goals of insulation as well as maintaining the overall magnetic property. The inductor of the invention thus has better magnetic permeability and saturation magnetic flux density, thereby contributing to high inductance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inductor comprising:
a coil; and
a magnetic body covering the coil and comprising at least one insulated magnetic material and at least one resin.

2. The inductor of claim 1, wherein the magnetic body further comprises at least one magnetic material.

3. The inductor of claim 2, wherein the magnetic material is in a form of powder or granules.

4. The inductor of claim 3, wherein the magnetic material comprises Fe, Si, Co, Ni, Al, Mo, or combinations thereof.

5. The inductor of claim 2, wherein the magnetic body is made by mixing the insulated magnetic material with the magnetic material.

6. The inductor of claim 2, wherein the insulated magnetic material envelops the magnetic material.

7. The inductor of claim 6, wherein the insulated magnetic material envelops the magnetic material by sol-gel, hydrothermal, co-precipitation, or coating.

8. The inductor of claim 1, wherein the insulated magnetic material is in a form of powder or granules.

9. The inductor of claim 1, wherein the insulated magnetic material is MnO.Fe₂O₃, NiO.Fe₂O₃, ZnO.Fe₂O₃ or a ferrite magnetic material.

10. The inductor of claim 1, wherein the insulated magnetic material occupies 1% to 10% of the magnetic body in volume.

11. The inductor of claim 1, wherein the resin occupies 10% to 40% of the magnetic body in volume.

12. The inductor of claim 1, wherein the resin comprises an inorganic resin.

13. The inductor of claim 12, wherein the inorganic resin is an aluminum silicates resin or a Si—Al—O based resins.

14. The inductor of claim 12, wherein the resin further comprises an organic resin or epoxy resin.

15. The inductor of claim 1, wherein the resin withstands a temperature higher than 400° C.

16. The inductor of claim 1, wherein the coil is made by winding a round wire, a square wire or a flat wire.

17. The inductor of claim 1, wherein two ends of the coil are used as pins of the inductor.

18. The inductor of claim 1, wherein two ends of the coil are connected with pins, respectively.

19. The inductor of claim 1, wherein the magnetic body is made by fully mixing the insulated magnetic material and the resin to form a mixture, adding a coupling agent to the mixture, melting the mixture, and applying the mixture into a mold for formation.

20. The inductor of claim 1, wherein a curing temperature of the magnetic body is between 150° C. and 300° C.
